(19) United States
(12) Patent Application Publication
(10) Pub. No.: US 2003/0000634 A1
(43) Pub. Date: Jan. 2, 2003

(54) Method and device for producing a dvd

(76) Inventor: Martin Eichlseder, Unterschrift des Erfinders (DE)

Correspondence Address: HENRY M FEIEREISEN, 350 FIFTH AVENUE, SUITE 3220, NEW YORK, NY, 10118, US

(21) Appl. No.: 10/169,795

(22) PCT Filed: Feb. 21, 2001
(86) PCT No.: PCT/EP01/01978

(30) Foreign Application Priority Data
Feb. 22, 2000 (DE) 100 08 109.6

(51) Int. Cl. B31F 1/00; B44C 1/00

(52) U.S. Cl. 156/237; 156/227; 156/361

(57) ABSTRACT

A process for producing a DVD from two DVD substrates A and B, wherein the first substrate (A-disc) of the DVD is produced by a first injection unit A and the second substrate (B-disc) of the DVD is produced by a second injection unit B, wherein one or both DVD substrates are coated, in particular metallised, in a coating station, wherein one or both DVD substrates are provided with an adhesive in an adhesive application station and wherein the DVD substrates A and B are supplied to at least one joining station for the purpose of joining the A-disc and B-disc to form a DVD. The invention is characterised in that at least one walking beam (12) is provided for transporting the DVD substrates A and B through the production line, in that the A-disc and the B-disc are alternately located behind one another in a row (A-B-A-B-A-B- . . . ) on the walking beam (12), and in that the walking beam is operated in double step fashion. In this way, the A substrates are always in the one same position, whereas the B substrates are always in the other same position which makes title tracking possible without sensor and software expenditure.

The invention relates to a process for producing a DVD according to the preamble of claim 1 and a device for carrying out the process according to the preamble of claim 11.

When producing a DVD the DVD substrates A and B, to be joined at a later stage, are initially produced in an injection moulding process by two injection units A and B. These substrates are then cooled, transported to one or more metallising stations and then to the actual bonding station which substantially comprises an adhesive application station and a joining station. Adhesives of the hot-melt type or a liquid, UV curing adhesive are conventionally used in the adhesive application station. The hot-melt adhesive is applied by means of a roller system equipped with a blade, wherein the substrates A and B located next to one another are moved through below the blade. The UV curing adhesive is applied to one or both substrates by means of a metering needle. The DVD substrates A and B are joined in the joining station and the adhesive is cured, wherein application of UV radiation is additionally required with the UV curing adhesive. The substrates are moved on transportation devices such as conveyor belts, spindles or a so-called “walking beam” to transport the DVD substrates A and B from the injection moulding machine through the entire production line up to the fully bonded DVD and are lifted and transferred (so-called pick and place) by means of handling systems of the transportation devices.

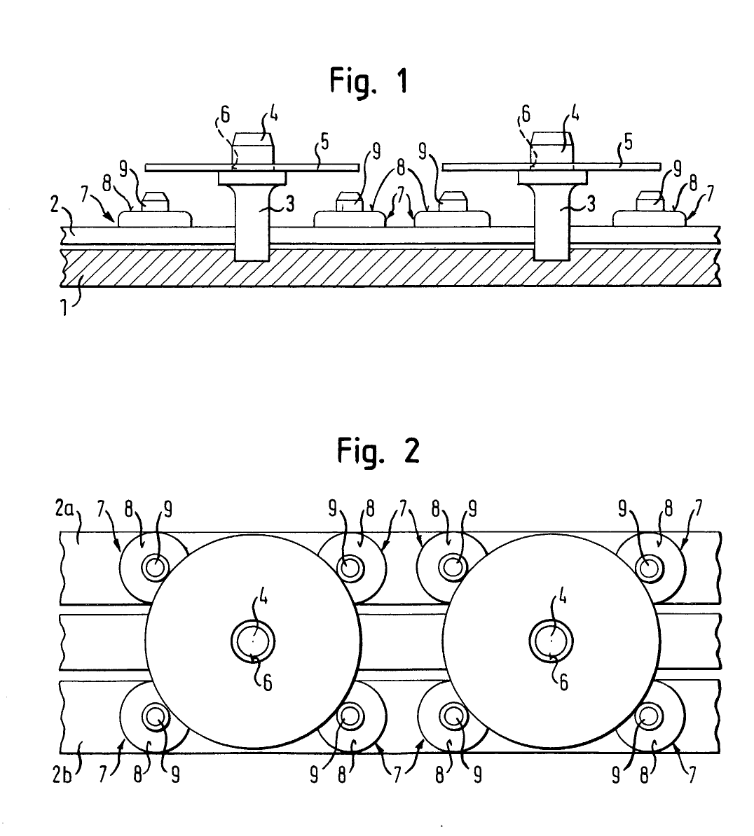

FIG. 1 and FIG. 2 show a detail of a “walking beam” transport system in side view and in plan view respectively. A complete walking beam transport system consists of a suitable number of units of the type shown in FIGS. 1 and 2. The precise number depends on the length of the transport path. This transport system consists of a horizontally stationary and vertically movable transport beam 1 (so-called “beam”) and transport frame 2 (so-called “walk”) movable in longitudinal direction and arranged coaxially to the transport beam. The transport frame has two substantially beam-like elements 2a and 2b which are arranged to the left and right of the transport beam 1 in plan view (see FIG. 2). Holding elements 7 which, in each case, have a bearing face 8 for the DVD substrate 5 and lateral fixing pins 9 are arranged on the beam-like elements 2a and 2b. Owing to the partially sectional view in FIG. 1, only the rear (left-hand or right-hand) element of the transport frame 2 is shown there. The transport beam 1 is fitted with a series of substantially cylindrical carriers 3 equipped with centring pins 4 on which the DVD substrates 5 are deposited, wherein in each case, the centring pin 4 penetrates through the central recess 6 in the DVD substrate. For the purpose of transportation, the DVD substrates 5 resting on the carriers 3 are initially deposited onto the bearing faces 8 of the holding elements 7 of the transport frame 2 by a downwards movement of the transport beam 1 and the centring pins 4 are subsequently removed from the bottom from the central recesses 6 of the DVD substrates 5. The transport frame 2 is then generally moved along a station in longitudinal direction until the series of DVD substrates 5 is positioned above the transport beam 1 in such a way that the central recesses 6 of the DVD substrates 5 are again located exactly above the generally adjacent carrier 3 and its centring pin 4. Owing to an upwards movement of the transport beam 1, the centring pins 4 engage in the recesses 6 of the DVD substrates 5 and the transport beam 1, with the carriers 3, lifts them from the transport frame 2. The transport frame (walk) is then moved back in the opposite direction into its starting position and the cycle begins again, i.e. the transport beam (beam) starts with the next downwards movement and so on.

When producing DVDs the substrates A produced by the injection unit A are deposited on a first transport device and the substrates B produced by the injection unit B are placed on a second transport device of the aforementioned type and are transported separately, generally parallel to one another, up to the and through the subsequent processing stations until an A substrate is grasped at the joining station of the A transport device and a B substrate is grasped at the joining station of the B transport device by means of a handling system and are deposited in the joining station in the correct sequence (U.S. Pat. No. 5,961,777). Owing to the separate, parallel transport of A substrate and B substrate to the joining station, it is ensured that an A substrate is always joined to a B substrate.

On the other hand, such a production process has numerous disadvantages. On the one hand, a double transport system requires a correspondingly large amount of space. In addition, the transport devices must be coordinated with one another in operation such that at the joining station an A substrate and a B substrate, in each case, are provided in the correct production cycle, in preference simultaneously. This requires a grasping process that ensures an A substrate is always correctly joined to a B substrate.

The use of a walking beam operated in double step fashion also has the advantage that a combination sputtering device which has two sputtering sources can be used instead of two separate metallisers in order to coat the substrates A and B, to be metallised, simultaneously. In order to be able to provide the combination sputtering device with substrates A and B in the shortest possible time, two tandem grippers are provided in accordance with sub-claims 3 and 14 which interact in such a way that a pair consisting of an A substrate and a B substrate is lifted from the walking beam by the first tandem gripper and is placed in the combination sputtering device while at the same time, the previously sputtered pair of A substrate and B substrate is removed by the second tandem gripper and deposited on the now free places on the walking beam, wherein the sequence on the walking beam, namely A-B-A-B-A-B . . . is maintained.

A further advantage when using a hot-melt type adhesive is that the substrates are moved through under the blade, one behind the other in a row, for adhesive application, so the blade can be approximately half the length compared with those of the state of the art, which considerably reduces the degree of deflection, and for this reason alone, the adhesive application is more uniform. In addition, both the A substrates and the B substrates always pass the roller system of the adhesive application station at the same point, so the application pattern between the A substrate and B substrate does not differ, this being in contrast to the state of the art. With regard to the supply of substrates A and B to the roller system of the adhesive application station, the substrates can be picked up simultaneously from the walking beam by a tandem gripper and transported onto the conveyor belt, or can be placed directly onto the conveyor belt by the beam of the walking beam without additional handling, which represents a time advantage compared with successive depositing. After leaving the adhesive application station, the substrates A and B coated with hot-melt adhesive are still in the A-B-A-B-A-B . . . sequence, so an A substrate and a B substrate are then grasped simultaneously by a tandem gripper and both can be transferred to the joining station. In a further advantageous development, the joining station has two foldable halves, which in the folded-together state form a vacuum chamber wherein the carrier for the lower disc is formed as a piston in the lower half as well and is subjected to compressed air for the purpose of pressing the substrates. Therefore, a combination of vacuum joining and pressing takes place at one station.

In contrast to the state of the art, separate grasping of an A substrate from the first transportation device and a B substrate from the second transportation device wherein it must additionally be ensured that the substrates are deposited in the bonding station in the correct sequence is additionally dispensed with by the present invention. As only one transportation device is used fewer handling and transfer stations are sufficient, in particular when only one walking beam is used.

The invention may be understood more readily, and various other aspects and features of the invention may become apparent, from consideration of the following description.

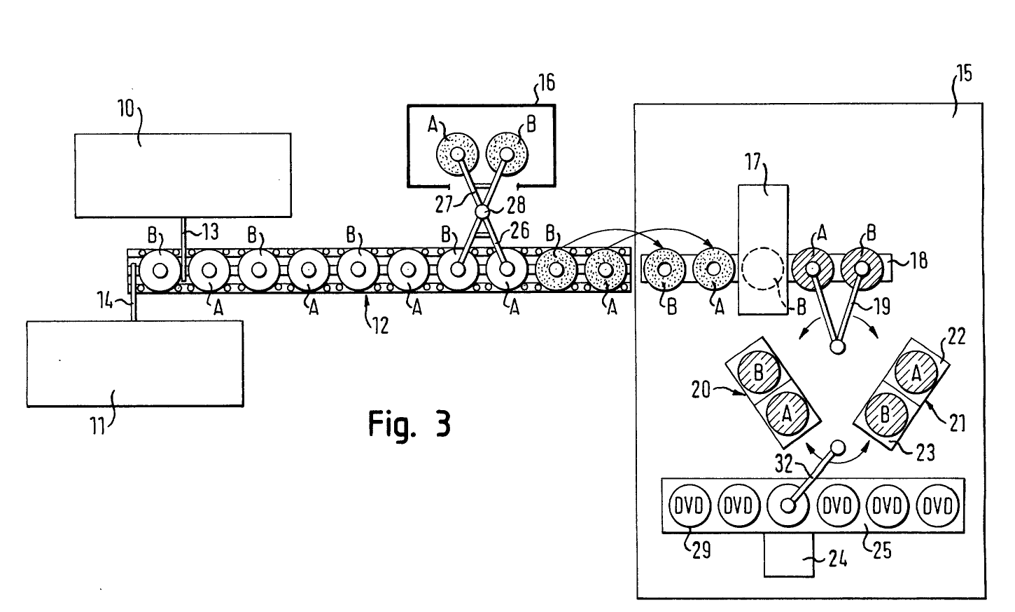

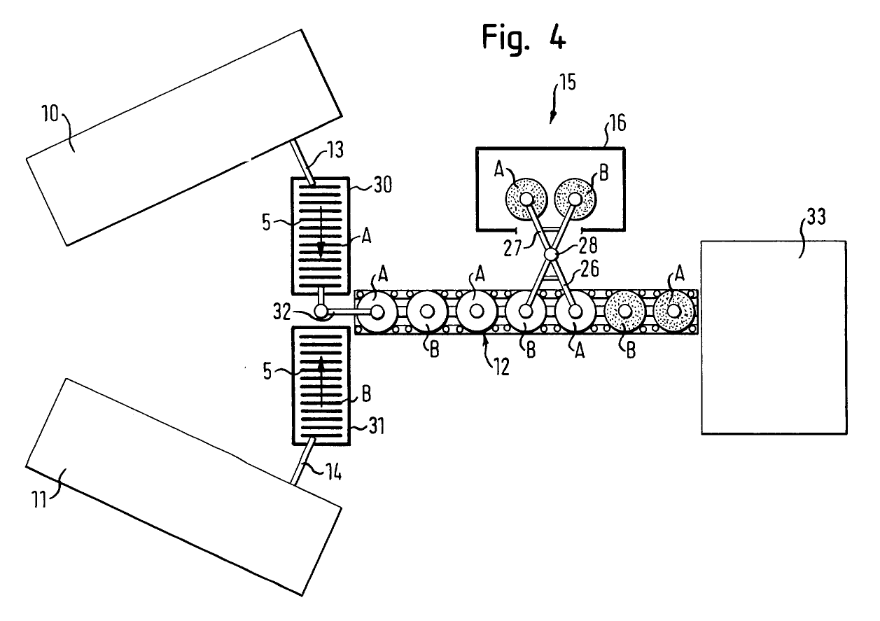

A preferred embodiment of the invention will now be described, by way of example only, with reference to the accompanying FIGS. 3 and 4.

FIG. 3 shows schematically a device according to the invention of the hot-melt bonder type. Two injection units 10 and 11 are arranged on either side of a walking beam 12 so as to be offset from one another, wherein the offset corresponds exactly to one stage of the walking beam. The DVD substrates A and B are deposited one behind the other in terms of location, but at the same time, on to the carriers on the walking beam 12 by means of transfer devices 13 and 14. By carrying out a double step, substrates A and B just deposited are moved along two stages in the direction of the bonding station 15. After the transport frame of the walking beam has been moved back, it can pick up another two substrates A and B in this sequence and move along two stages in the direction of the bonding station. The substrates A and B are located on the walking beam 12 behind one another in each case therefore and form a row A-B-A-B-A-B-A-B- etc. During transportation, the DVD substrates are simultaneously cooled, passively by ambient air, or actively by a supply of fresh air. A combination sputtering device with two sputtering sources is provided in the metallising station 16. Two tandem grippers 26 and 27 can be rotated about a vertical axis 28 and in each case grasp a pair consisting of a substrate A and a substrate B. The first tandem gripper 26 grasps a still uncoated pair A and B from the walking beam 12, while the second tandem gripper 27 simultaneously grasps the just coated pair A and B in the combination sputtering device 16 (wherein one substrate or both substrates, depending on the DVD type, are coated, generally with an aluminium or a gold layer). By rotating the two tandem grippers 26, 27 about the axis 28, the still uncoated substrates A and B are passed from the first tandem gripper 26 into the combination sputtering device 16, while the second tandem gripper 27 transports the just coated substrates A and B (illustrated by dots) to the walking beam 12 and deposits them there on the now vacated places and automatically does this in the correct sequence. The walk (transport frame) 2 extends over the conveyor belt 18 for two stations and the beam (transport beam) 1 lifts the A substrate and the B substrate. The walk then travels back two stations and the beam 1 travels downwards, wherein the substrates A and B are placed on the conveyor belt 18 of the adhesive application station 17. As a result, handling of the so-called pick and place type is omitted. Subsequently, the substrates A and B are moved one behind the other through the roller system of the hot-melt adhesive application station, wherein the adhesive is rolled onto the substrate by a comparatively short blade. After leaving the adhesive application station 17, the substrates A and B coated with adhesive are grasped simultaneously and in the correct position by a further tandem gripper 19 and simultaneously deposited in one of the joining stations 20 or 21, wherein the substrates A and B are processed symmetrically. The joining stations consist of two foldable halves 22 and 23. The A substrate is deposited in the one half and the B substrate in the other half. The substrates are fixed and centred in the halves in a suitable manner, for example on vacuum plates and with centring pins. When the halves are folded together, they form a chamber which is evacuated. The two substrates A and B are drawn towards one another and bonded under the influence of the vacuum. Pressure is additionally exerted from above and/or below for the purpose of pressing. To this end, the substrate carrier of the lower substrate is preferably pressed upwards by means of compressed air. To this end, this substrate carrier can be attached to a piston/cylinder unit or the substrate carrier itself can be moved as piston in the lower half of the joining station and can be subjected directly to compressed air, so a two chamber system, namely a low pressure chamber between the substrates A and B which can be evacuated and an excess pressure chamber below the piston which can be filled with compressed air, is formed. After the joining process has terminated, the vacuum chamber is opened and the finished DVD can be removed, checked in a scanner 24 and finally, if it is judged to be good, can be deposited on good part spindles 29. The stacking spindles 29 are arranged on a revolving table or, as illustrated here, on a linear transporter 25 in walking beam design. Such a linear transporter 25 can receive a larger number of stacking spindles 29 more easily in comparison with a revolving table, so if required, a smaller number of DVDs can be deposited on each stacking spindle if the pressure load on the lowermost DVDs is to be reduced.

FIG. 4 shows schematically a device according to the invention of the UV adhesive type. The injection units 1 and 2 for the A and B substrate are arranged obliquely to a DVD bonding station 15 with an integrated combination sputtering device 16. The injection moulded substrates A and B are deposited vertically in the spindle cooler 30 and 31 by the transfer devices 13 and 14. By rotating the individual spindles, the substrates 5 in the vertical position are moved in the direction of the walking beam 12 (see arrow) and subjected to cooling air in the process. An A substrate is removed from the spindle cooler 30 and a B substrate is removed from the spindle cooler 31 by means of a pick and place 32 and are deposited behind one another on the walking beam 12, so the substrates are located in a series A-B-A-B-A-B- . . . behind one another on the walking beam. A combination sputtering device is provided at the metallising station 16 which is fitted with two tandem grippers 26 and 27 in the same way and is emptied as was described for the hot-melt type bonder described in conjunction with FIG. 3. After coating, the substrates were transported on in the sequence A-B-A-B-A-B . . . to the UV adhesive station 33 where aUV curing adhesive is applied in a manner known per se to one or both substrates, the substrates A and B are then joined together, the UV adhesive is spun off and the bonded DVD is timed under a UV lamp where the UV adhesive can be cured.

List of reference numerals

| | |
|---|---|
| 1 | transport beam |
| 2 | transport frame |
| 2a, 2b | beam-shaped lateral parts of the transport frame |
| 3 | carrier |
| 4 | centring pin |
| 5 | DVD substrate |
| 6 | centring recess in the DVD substrate |
| 7 | holding elements |
| 8 | bearing face |
| 9 | fixing pin |
| 10 | injection unit for A substrate |
| 11 | injection unit for B substrate |
| 12 | walking beam |
| 13 | transfer device for A substrate |
| 14 | transfer device for B substrate |
| 15 | bonding station |
| 16 | metallising station (combination sputtering device) |
| 17 | adhesive application station |
| 18 | conveyor belt |
| 19 | tandem gripper at joining station |
| 20 | first joining station |
| 21 | second joining station |
| 22 | first half of a joining station |
| 23 | second half of a joining station |
| 24 | scanner for quality control |
| 25 | linear transporter in walking beam design |
| 26 | first tandem gripper at metallising station |
| 27 | second tandem gripper at metallising station |
| 28 | rotational axis of the tandem grippers 26 and 27 |
| 29 | stacking spindles |
| 30 | spindle cooler for A substrate |
| 31 | spindle cooler for B substrate |
| 32 | pick and place |
| 33 | UV bonding station |

1. A process for producing a DVD from two DVD substrates A and B, wherein the first substrate (A-disc) of the DVD is produced by a first injection unit A and the second substrate (B-disc) of the DVD is produced by a second injection unit B, wherein one or both DVD substrates are coated, in particular metallised, in a coating station wherein one or both DVD substrates are provided with an adhesive in an adhesive application station and wherein the DVD substrates A and B are supplied to at least one joining station for the purpose of joining the A-disc and B-disc to form a DVD, characterised in that at least one walking beam (12) is provided for transporting the DVD substrates A and B, in that the A-disc and the B-disc are alternately located behind one another in a row (A-B-A-B-A-B- . . . ) on the walking beam (12), and in that the walking beam is operated in double step fashion.

2. A process according to claim 1, characterised in that an A-disc and a B-disc are removed simultaneously from the walking beam (12) at the coating station (16), and in that after coating on the same or a further walking beam (12) the substrates A and B are deposited behind one another viewed in the transport direction.

3. A process according to claim 1 or 2, characterised in that two tandem grippers (26, 27) are provided at the coating station (16), in that a pair consisting of an A substrate and a B substrate is removed from the walking beam (12) by the first tandem gripper (26) and placed in a sputtering device, and in that the previously sputtered pair of A substrate and B substrate is removed by the second tandem gripper (27) and deposited on the previously vacated places of the walking beam (12) (two in, two out).

4. A process according to one of claims 1 to 3, characterised in that a hot-melt adhesive which can be applied by means of a roller system is provided for bonding the DVD substrates (5), in that the substrates A and B are passed in the arrival sequence A-B-A-B-A-B . . . from the walking beam (12) onto a conveyor belt (18) running through the roller system and pass through the roller system in this sequence.

5. A process according to one of claims 1 to 4, characterised in that the substrates A and B coated with adhesive are simultaneously grasped by a tandem gripper (19), simultaneously moved to a joining station (20, 21) and are simultaneously deposited there.

6. A process according to one of claims 1 to 5, characterised in that the substrates A and B coated with adhesive are deposited in a joining station (20, 21) which consists of two folding halves (22, 23), wherein the A-disc is deposited in the one half and the B-disc is deposited in the other half, wherein depositing takes place simultaneously and wherein the two substrates A and B are joined after the halves are folded together.

7. A process according to claim 6, characterised in that after the halves of the joining station (20, 21) have been folded together, these form a chamber and this chamber is evacuated.

8. A process according to claim 6 or 7, characterised in that the lower disc rests on a piston which can be displaced in the chamber and the piston is subjected to pressure, in particular to compressed air, from below.

9. A process according to one of claims 1 to 8, characterised in that the injection units A and B (10, 11) are arranged on either side of a first walking beam (12) and in the direction of transport are offset from one another in such a way that the respective substrates A and B are passed directly to the first walking beam (12) and can be simultaneously deposited behind one another in the direction of transport.

10. A process according to one of claims 1 to 9, characterised in that the DVD substrates A and B are subjected to cooling air after their removal from the injection units A and B (10, 11), for example in a spindle cooler (30, 31), or during transportation on the first walking beam (12).

11. A device for producing a DVD, in particular for carrying out the process according to one of claims 1 to 10, with two injection units A and B for producing the DVD substrates, wherein the first substrate (A-disc) of a DVD is produced by the first injection unit A and the second substrate (B-disc) is produced by the second injection unit B, with a coating device for coating, in particular for metallising the DVD substrates by an adhesive application station, with at least one joining station for joining A-disc and B-disc, and means for transporting the DVD substrates and the finished DVDs, characterised in that at least one walking beam (12) is provided for transporting the DVD substrates A and B, wherein the A-disc and the B-disc are alternately located behind one another in a row (A-B-A-B-A-B- . . . ) on the walking beam (12), and wherein the walking beam or beams (12) can be moved in double step fashion.

12. A device according to claim 11, characterised in that a cooling station, in particular of the spindle cooling type (30, 31) is provided for cooling the DVD substrates A and B after their removal from the injection units A and B (10, 11), in that a walking beam (12) which can be moved in double step fashion is provided for transporting the cooled substrates A and B to the coating device (16), and in that means (32) are provided for transferring the substrates A and B from the cooling station onto the above-mentioned walking beam (12) in the sequence A-B-A-B-A-B.

13. A device according to claim 11 or 12, characterised in that tandem grippers (26, 27) are provided at the coating station (16) for simultaneous grasping of an A substrate and a B substrate in each case.

14. A device according to claim 13, characterised in that two tandem grippers (26, 27) located opposite one another are provided which interact in such a way that a pair consisting of an A substrate and a B substrate is removed from the walking beam (12) by the one tandem gripper (26) and placed in the coating device (16), preferably in a combination sputtering device equipped with two sputtering sources, and in that the previously coated pair of A substrate and B substrate is removed by the second tandem gripper (27) and deposited on the previously vacated places on the walking beam (12) (two in, two out).

15. A device according to one of claims 11 to 14, characterised in that a hot-melt adhesive which can be applied by means of a roller system is provided in the adhesive application station (17), in that a walking beam (12) which can be moved in double step fashion is provided for transporting the DVD substrates to the adhesive application station (17), and in that the DVD substrates can be passed in the arrival sequence A-B-A-B-A-B . . . from the above-mentioned walking beam (12) onto a conveyor belt (18) running through the roller system and can pass through the roller system in this sequence.

16. A device according to claim 15, characterised in that the walk (2) or the beam (1) or both are designed so as to extend over the conveyor belt (18) of the adhesive application station (17).

17. A device according to one of claims 11 to 13, characterised in that one or more tandem grippers (19) are provided with which the A-disc and the B-disc can simultaneously be grasped and transferred in the correct position.

18. A device according to one of claims 11 to 17, characterised in that the joining station (20, 21) consists of two foldable halves (22, 23), wherein the one half is provided for receiving the A-disc and the other half for receiving the B-disc, and in that in the folded-together state, the halves form a chamber which can be evacuated.

19. A device according to claim 18, characterised in that a piston is provided for holding the lower disc, wherein the piston can be subjected to pressure, in particular compressed air, for pressing the substrate.

20. A device according to one of claims 11 to 19, characterised in that the injection units A and B (10, 11) are arranged on either side of the first walking beam (12) and in the direction of transport are offset from one another in such a way that the respective substrates A and B are passed directly to the first walking beam and can be deposited behind one another in the direction of transport.
